(19) United States
(12) Patent Application Publication
(10) Pub. No.: US 2026/0088946 A1
(43) Pub. Date: Mar. 26, 2026

(54) METHOD FOR SYNCHRONIZING AND CONTROLLING BACKSCATTER COMMUNICATION BASED ON AMBIENT CELLULAR OFDM SIGNAL

(71) Applicant: University of Electronic Science and Technology of China, Chengdu (CN)

(72) Inventors: Gang YANG, Chengdu (CN); Yuan HU, Chengdu (CN)

(73) Assignee: University of Electronic Science and Technology of China, Chengdu (CN)

(21) Appl. No.: 19/405,224

(22) Filed: Dec. 1, 2025

Related U.S. Application Data
(63) Continuation of application No. PCT/CN2024/107290, filed on Jul. 24, 2024.

(30) Foreign Application Priority Data
Jan. 31, 2024 (CN) 202410143770.5

(51) Int. Cl. H04L 5/00; H04W 56/00

(52) U.S. Cl. CPC H04L 5/0007; H04L 5/0098; H04W 56/0015

(57) ABSTRACT

A method for synchronizing and controlling backscatter communication based on an ambient cellular OFDM signal includes the following steps: S10, transmitting, by a transmitting terminal, an ambient cellular OFDM signal, which carries synchronization and control information; and S20, acquiring, by a backscatter tag, the synchronization and control information from the ambient cellular OFDM signal, including: utilizing, by the backscatter tag, an envelope-detection circuit to convert the ambient cellular OFDM signal into a digital pulse signal; establishing, by the backscatter tag, synchronization with the transmitting terminal by detecting a rising edge of the digital pulse signal; and identifying, by the backscatter tag, the control information of the transmitting terminal by detecting multi-segment pulse widths of the digital pulse signal.

### CROSS-REFERENCE TO RELATED APPLICATIONS

This application is a continuation application of International Application No. PCT/CN2024/107290, filed on Jul. 24, 2024, which claims priority to Chinese Patent Application No. 202410143770.5, filed on Jan. 31, 2024. The disclosures of the above-mentioned application are incorporated herein by reference in their entireties.

### TECHNICAL FIELD

The present application relates to the field of wireless communication technology. More specifically, it relates to a method for synchronizing and controlling backscatter communication based on an ambient cellular Orthogonal Frequency Division Multiplexing (OFDM) signal.

### BACKGROUND

New-generation mobile communications (5G/6G), intelligent vehicle networking, mobile healthcare, smart home, industrial control, environmental monitoring and other applications are driving large-scale expansion of the Internet of Things (IoT). Trillions of sensing devices will be connected to the network, enabling true intelligent interconnection of all things. However, during a rapid growth of the number of IoT devices, power consumption and cost issues brought about by classic wireless communication technologies need to be urgently addressed. In recent years, a backscatter technology has emerged as an effective solution for low-power and low-cost IoT technologies. Nevertheless, most backscatter systems require deployment of additional excitation sources, which increases deployment costs of low-power IoT devices. A backscatter communication system based on ambient cellular signals takes advantage of a ubiquitous nature of cellular signals, making it easy to achieve low-power, low-cost, and wide-coverage IoT connections.

In a process of reflecting the ambient cellular signals, to ensure that a Cyclic Prefix (CP) part is consistent with a replicated part and no useful information is modulated onto the CP (otherwise it will be deleted by a receiver), tags need to perform coarse synchronization first. In a general cellular network, synchronization of a receiving end is achieved through correlation of received signals. Such complexity is unaffordable for low-power tags. In addition, although many existing backscatter systems have endowed the tags with strong uplink capabilities, there is a lack of sufficient research on tag control issues.

### SUMMARY

In order to overcome the deficiencies of the prior art, the present application provides a method for synchronizing and controlling backscatter communication based on an ambient cellular OFDM signal.

A technical solution adopted by the present application to solve the technical problem thereof is as follows: A method for synchronizing and controlling backscatter communication based on an ambient cellular OFDM signal. Its improvement lies in that the method comprises the following steps:
S10, transmitting, by a transmitting terminal, an ambient cellular OFDM signal, which carries synchronization and control information; and
S20, acquiring, by a backscatter tag, the synchronization and control information from the ambient cellular OFDM signal, comprising:
utilizing, by the backscatter tag, an envelope-detection circuit to convert the ambient cellular OFDM signal into a digital pulse signal;
establishing, by the backscatter tag, synchronization with the transmitting terminal by detecting a rising edge of the digital pulse signal; and
identifying, by the backscatter tag, the control information of the transmitting terminal by detecting multi-segment pulse widths of the digital pulse signal.

Further, step S10 comprises the following steps:
S101, increasing, by the transmitting terminal, a Primary Synchronization Signal (PSS) signal for synchronization with the backscatter tag, wherein the PSS signal is a primary synchronization signal;
S102, generating, by the transmitting terminal, a corresponding control sequence according to a tag needed to be controlled; and
S103, mapping, by the transmitting terminal, bit information corresponding to the control sequence to a relative size of power of a Secondary Synchronization Signal (SSS) signal.

Further, the control sequence is a Pseudorandom Noise (PN) pseudo-random sequence, and the SSS signal is a secondary synchronization signal.

Further, in the step S101, the transmitting terminal increases the transmission power of the PSS signal of the ambient cellular OFDM signal by several dBs, so that the power of an OFDM symbol where the PSS signal is located is relatively large, and the rising edge is capable of being detected by the backscatter tag in an envelope-detection manner.

Further, in the step S102, the transmitting terminal utilizes a control sequence of an appropriate length to distinguish different backscatter tags according to the number of backscatter tags needed to be controlled.

Further, in the step S103, in Long Term Evolution (LTE), the PSS signal and the SSS signal exist in two consecutive OFDM symbols; and
in 5G New Radio (NR), the PSS signal and the SSS signal exist in the same Synchronization Signal Block (SSB) block, which are two relatively close OFDM symbols, and the SSB block is a synchronization signal and physical broadcast channel block.

Further, in the step S20, the envelope-detection circuit comprises an impedance-matching circuit, an envelope-detection circuit, a base-band amplification circuit, a filtering circuit, and a comparator, which are electrically connected in sequence; and
utilizing, by the backscatter tag, an envelope-detection circuit to convert the ambient cellular OFDM signal into a digital pulse signal comprises:

S201, after the ambient cellular OFDM signal passes through the impedance-matching circuit, receiving only an ambient cellular OFDM signal in a frequency band carrying the synchronization information, while suppressing ambient signals in other frequency bands;
S202, acquiring a signal envelope when the received ambient cellular OFDM signal passes through the envelope-detection circuit, and then improving a signal-to-noise ratio by the base-band amplification circuit; and
S203, using, by the backscatter tag, the filtering circuit and the comparator to convert the synchronization information into a digital pulse signal that is capable of being read by a tag control module.

Further, in the step S20, establishing, by the backscatter tag, synchronization with the transmitting terminal by detecting a rising edge of the digital pulse signal comprises:
determining, by the backscatter tag, an appearance time of the PSS signal by capturing the rising edge of the digital pulse signal and establishing time synchronization with the transmitting terminal, so as to avoid backscatter tag information being modulated to a CP part of the ambient cellular OFDM signal.

Further, in the step S20, identifying, by the backscatter tag, the control information of the transmitting terminal by detecting multi-segment pulse widths of the digital pulse signal comprises:
S204, collecting, by the backscatter tag, a plurality of pulse widths of the digital pulse signal and averaging the pulse widths to obtain a decision threshold;
S205, performing 0-1 decisions on the pulse widths of the digital pulse signal and storing a result thereof;
S206, every time a control bit is collected, utilizing, by the backscatter tag, a shift register to update the plurality of stored bits; using data of these bits by the backscatter tag to perform a correlation calculation with a corresponding PN sequence thereof, comparing a peak value of the calculation result with a preset threshold to determine whether a current backscatter tag is a target backscatter tag controlled by the transmitting terminal, and determining a start time of backscattering from a peak point of the correlation calculation; and
S207, if the current backscatter tag is the target backscatter tag controlled by the transmitting terminal, starting backscattering at this time backscattering of a previous backscatter tag is finished, which completes control of a backscatter communication process of the backscatter tag by the transmitting terminal.

Further, in the step S205, the shift register is utilized to store multiple groups of pulse widths of the digital pulse signal.

The beneficial effects of the present application are as follows: the method for synchronizing and controlling backscatter communication based on an ambient cellular OFDM signal of the present application is applicable to ambient cellular OFDM signals of any bandwidth; and the present application is capable of achieving reliable synchronization and control without relying on additional excitation signals, which is an urgent problem to be solved in the current backscatter communication technology.

### BRIEF DESCRIPTION OF THE DRAWINGS

FIG. 1 is a schematic flowchart of a method for synchronizing and controlling backscatter communication based on an ambient cellular OFDM signal according to the present application.

FIG. 2 is a schematic diagram of a system model of the method for synchronizing and controlling backscatter communication based on an ambient cellular OFDM signal according to the present application.

FIG. 3 is a flowchart of synchronization and control steps for backscatter communication based on an ambient cellular OFDM signal according to the present application.

FIG. 4 is a structural diagram of an envelope detection circuit of a backscatter tag according to the present application.

FIG. 5 is a schematic diagram of a control process of a backscatter tag according to the present application.

FIG. 6 shows simulation results of correlation performance of a PN sequence adopted in the present application.

FIG. 7 shows a performance test result of a method for controlling backscatter communication based on an ambient cellular OFDM signal according to the present application.

FIG. 8 shows a performance test result of a method for synchronizing backscatter communication based on an ambient cellular OFDM signal according to the present application.

### DETAILED DESCRIPTION OF THE EMBODIMENTS

The present application will be further described below in conjunction with the accompanying drawings and embodiments.

Concepts specific structures and technical effects of the present application will be clearly and completely described below in conjunction with the embodiments and the accompanying drawings, so as to fully understand purposes, features, and effects of the present application. Obviously, the described embodiments are only a part of the embodiments of the present application, rather than all of them. Based on the embodiments of the present application, other embodiments obtained by those skilled in the art without creative efforts shall all fall within a protection scope of the present application. In addition, all the coupling or connection relationships involved in the patent do not simply mean that components are directly connected. Instead, according to specific implementation situations, by adding or reducing connection auxiliary components, a better connection structure can be formed. All technical features in the present application can be combined interactively on the premise that there is no contradiction or conflict among them.

### Embodiment 1

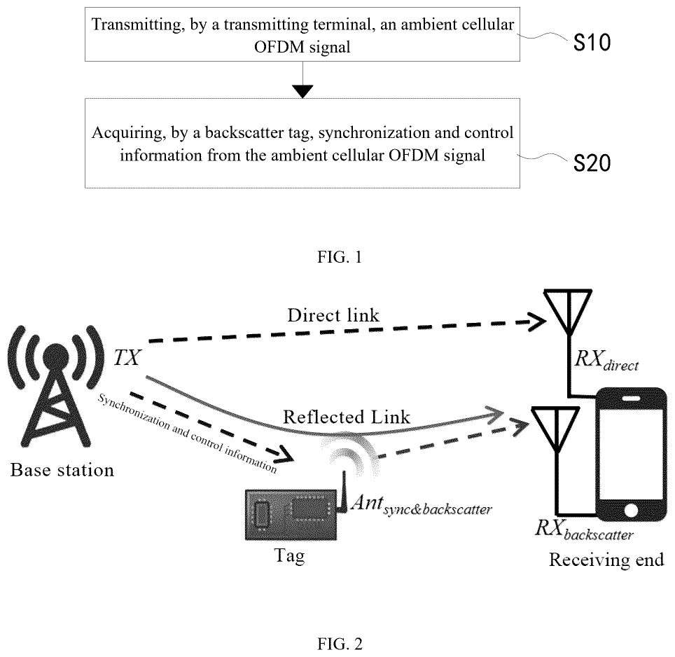

Referring to FIG. 1, the present application provides a method for synchronizing and controlling backscatter communication based on an ambient cellular OFDM signal. As shown in FIG. 2, the method of the present application is implemented on a synchronization and control system for backscatter communication based on an ambient cellular OFDM signal. The system consists of a transmitting terminal, a backscatter tag, and a receiving end, wherein the transmitting terminal is a base station shown in FIG. 2, and the backscatter tag is a tag in FIG. 2. The transmitting terminal transmits a downlink ambient cellular OFDM signal in a certain frequency band to communicate with the receiving end, forming a direct link. Meanwhile, this ambient cellular OFDM signal also wakes up the backscatter tag, provides it with a continuous synchronization and control signal, and serves as a carrier to support low-power backscatter communication of the backscatter tag.

In this embodiment, the present application provides a method for synchronizing and controlling backscatter communication based on an ambient cellular OFDM signal, which comprises steps S10 to S20:
S10, transmitting, by a transmitting terminal, an ambient cellular OFDM signal, which carries synchronization and control information.

The step S10 comprises steps S101 to S103:
S101, increasing, by the transmitting terminal, a PSS signal for synchronization with the backscatter tag, wherein the PSS signal is a primary synchronization signal, and in this embodiment, the SSS signal is a secondary synchronization signal; in the step S101, the transmitting terminal increases the transmission power of the PSS signal of an LTE signal by several dBs, so that the power of an OFDM symbol where the PSS signal is located is relatively large, and the rising edge is capable of being detected by the backscatter tag in an envelope-detection manner; and since the PSS signal has a period of 5 ms in LTE, the backscatter tag is capable of establishing synchronization with the ambient cellular OFDM signal once every 5 ms;
S102, generating, by the transmitting terminal, a corresponding control sequence according to a tag needed to be controlled, wherein the control sequence should have good autocorrelation and cross-correlation characteristics, wherein in this embodiment, the control sequence is a PN pseudo-random sequence, but it should be noted that the PN pseudo-random sequence is only used as an example in this embodiment, and other alternative control sequences are still within the scope of the present application; and further, in the step S102, the transmitting terminal utilizes a PN pseudo-random sequence of an appropriate length to distinguish different backscatter tags according to the number of backscatter tags needed to be controlled; and
S103, mapping, by the transmitting terminal, bit information corresponding to the control sequence to a relative size of power of the SSS signal, wherein in this embodiment, in the LTE, the PSS signal and the SSS signal are present in two consecutive OFDM symbols; and in another embodiment, in the 5G NR, the PSS signal and the SSS signal are in the same SSB, which are two relatively close OFDM symbols, and the SSB block is a synchronization signal and physical broadcast channel block.

S20, acquiring, by a backscatter tag, the synchronization and control information from the ambient cellular OFDM signal, including: utilizing, by the backscatter tag, an envelope-detection circuit to convert the ambient cellular OFDM signal into a digital pulse signal; establishing, by the backscatter tag, synchronization with the transmitting terminal by detecting a rising edge of the digital pulse signal; and identifying, by the backscatter tag, the control information of the transmitting terminal by detecting multi-segment pulse widths of the digital pulse signal.

In the step S20, the envelope-detection circuit comprises an impedance-matching circuit, an envelope-detection circuit, a base-band amplification circuit, a filtering circuit, and a comparator, which are electrically connected in sequence.

In this embodiment, utilizing, by the backscatter tag, an envelope-detection circuit to convert the ambient cellular OFDM signal into a digital pulse signal comprises:
S201, after the ambient cellular OFDM signal passes through the impedance-matching circuit, receiving only an ambient cellular OFDM signal in a frequency band carrying the synchronization information, while suppressing ambient cellular OFDM signals in other frequency bands;
S202, acquiring a signal envelope when the received ambient cellular OFDM signal passes through the envelope-detection circuit, and then improving a signal-to-noise ratio by the base-band amplification circuit; and
S203, using, by the backscatter tag, the filtering circuit and the comparator to convert the synchronization information into a digital pulse signal that is capable of being read by a tag control module.

Further, in the step S20, establishing, by the backscatter tag, synchronization with the transmitting terminal by detecting a rising edge of the digital pulse signal comprises: determining, by the backscatter tag, appearance time of the PSS signal by capturing the rising edge of the digital pulse signal and establishing time synchronization with the transmitting terminal, so as to avoid backscatter tag information being modulated to a CP part of the ambient cellular OFDM signal.

Still further, in the step S20, identifying, by the backscatter tag, the control information of the transmitting terminal by detecting multi-segment pulse widths of the digital pulse signal comprises:
S204, collecting, by the backscatter tag, a plurality of pulse widths of the digital pulse signal and averaging the pulse widths to obtain a decision threshold;
S205, performing 0-1 decisions on the pulse widths of the digital pulse signal and storing a result thereof, wherein in this embodiment, a shift register is utilized to store the pulse widths of the digital pulse signal and the judgment result;
S206, every time a control bit is collected, utilizing, by the backscatter tag, a shift register to update the plurality of stored bits; using data of these bits by the backscatter tag to perform a correlation calculation with a corresponding PN pseudo-random sequence corresponding thereto once, comparing a peak value of the calculation result with a preset threshold to determine whether a current backscatter tag is a target backscatter tag controlled by the transmitting terminal, and determining a start time of backscattering from a peak point of the correlation calculation; and
S207, if the current backscatter tag is the target backscatter tag controlled by the transmitting terminal, starting backscattering at this time backscattering of a previous backscatter tag is finished, which completes control of a backscatter communication process of the backscatter tag by the transmitting terminal.

On this basis, the present application provides a method for synchronizing and controlling backscatter communication based on an ambient cellular OFDM signal, which is applicable to ambient cellular OFDM signals of any bandwidth. When the power and frequency band of the ambient cellular OFDM signal received by the backscatter tag match, synchronization between backscatter tags within a range of 12 meters and the transmitting terminal and control of the backscatter tags by the transmitting terminal can be achieved. The present application is capable of achieving reliable synchronization and control without relying on additional excitation signals, which is an urgent problem to be solved in the current backscatter technology.

### Embodiment 2

As shown in FIG. 1 and FIG. 2, the present application provides a method for synchronizing and controlling backscatter communication based on an ambient cellular OFDM signal. As shown in FIG. 2, the method of the present application is implemented on a synchronization and control system for backscatter communication based on an ambient cellular OFDM signal. The system consists of a transmitting terminal, a backscatter tag, and a receiving end, wherein the transmitting terminal is a base station shown in FIG. 2, and the backscatter tag is a tag in FIG. 2. The transmitting terminal transmits a downlink ambient cellular OFDM signal in a certain frequency band to communicate with the receiving end, forming a direct link.

Meanwhile, this ambient cellular OFDM signal also wakes up the backscatter tag, provides it with a continuous synchronization and control signal, and serves as a carrier to support low-power backscatter communication of the backscatter tag. The backscatter tag acquires control and synchronization signals from the ambient cellular OFDM signal through an envelope detection. When the target backscatter tag is activated, coarse synchronization can be achieved by utilizing the rising edge of the synchronization signal, preventing information from being modulated to the CP part of the ambient OFDM signal and effectively backscattering information onto the ambient cellular OFDM signal.

To facilitate the description of the method for synchronizing and controlling backscatter communication based on an ambient cellular OFDM signal provided by the present application, in this embodiment, the ambient cellular OFDM signal transmitted in the step S10 is an LTE OFDM signal. However, it should be noted that other ambient cellular OFDM signal may utilize the same principle for synchronization and control of backscatter communication.

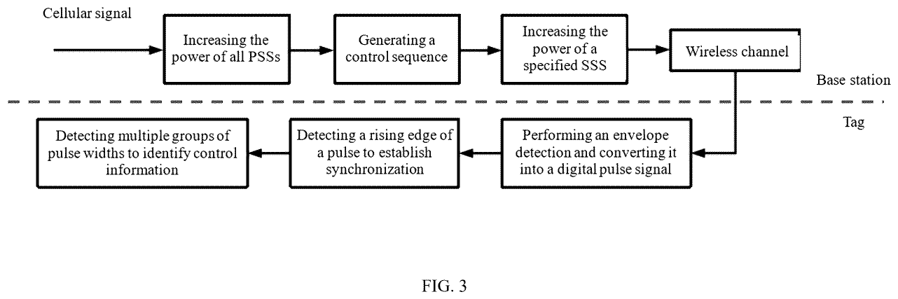

As shown in FIG. 3, it is a flowchart of synchronization and control steps for backscatter communication based on an ambient cellular OFDM signal according to the present application. Specifically, it comprises steps S10 to S20:
S10, transmitting, by a transmitting terminal, an ambient cellular OFDM signal, which carries synchronization and control information.
The step S10 comprises steps S101 to S103:
S101, increasing, by the transmitting terminal, a PSS signal for synchronization with the backscatter tag, wherein the PSS signal is a primary synchronization signal, and in this embodiment, the SSS signal is a secondary synchronization signal; in the step S101, the transmitting terminal increases the transmission power of the PSS signal of an LTE signal by several dBs, so that the power of an OFDM symbol where the PSS signal is located is relatively large, and the rising edge is capable of being detected by the backscatter tag in an envelope-detection manner; and since the PSS signal has a period of 5 ms in LTE, the backscatter tag is capable of establishing synchronization with the ambient cellular OFDM signal once every 5 ms;
S102, generating, by the transmitting terminal, a corresponding control sequence according to a tag needed to be controlled, wherein the control sequence should have good autocorrelation and cross-correlation characteristics, wherein in this embodiment, the control sequence is a PN pseudo-random sequence, but it should be noted that the PN pseudo-random sequence is only used as an example in this embodiment, and other alternative control sequences are still within the scope of the present application; and further, in the step S102, the transmitting terminal utilizes a PN pseudo-random sequence of an appropriate length to distinguish different backscatter tags according to the number of backscatter tags needed to be controlled; and in this embodiment, the transmitting terminal utilizes an m-sequence having a length of 31 bits as the PN pseudo-random sequence for controlling the backscatter tag, and different backscatter tags are distinguished by different m-sequences.
S103, mapping, by the transmitting terminal, bit information corresponding to the control sequence to a relative size of power of an SSS signal, wherein in this embodiment, in the LTE, the PSS signal and the SSS signal are present in two consecutive OFDM symbols.

In this embodiment, the PN pseudo-random sequence generated with a feedback coefficient of 37 is a sequence having a length of 31, namely 0000101011101100011111001101001, which contains 16 bits of 1 and 15 bits of 0. The above sequence is mapped to 31 SSS signals. For the bit 0, the power of the SSS signal remains unchanged compared with that in a general LTE system. For the bit 1, the power of the SSS signal is increased by several dBs at the transmitting terminal. Since the PSS and SSS signals in the LTE signal are present in two consecutive OFDM symbols, in the envelope of the LTE signal transmitted by the transmitting terminal, the pulse width corresponding to a region where the bit 1 is mapped is widened compared with that of the bit 0. These pulse width changes caused by the relative size of the powers of the 31 SSS signals carry the control information of the transmitting terminal for the backscatter tag.

S20, acquiring, by a backscatter tag, the synchronization and control information from the ambient cellular OFDM signal, including: utilizing, by the backscatter tag, an envelope-detection circuit to convert the ambient cellular OFDM signal into a digital pulse signal; establishing, by the backscatter tag, synchronization with the transmitting terminal by detecting a rising edge of the digital pulse signal; and identifying, by the backscatter tag, the control information of the transmitting terminal by detecting multi-segment pulse widths of the digital pulse signal.

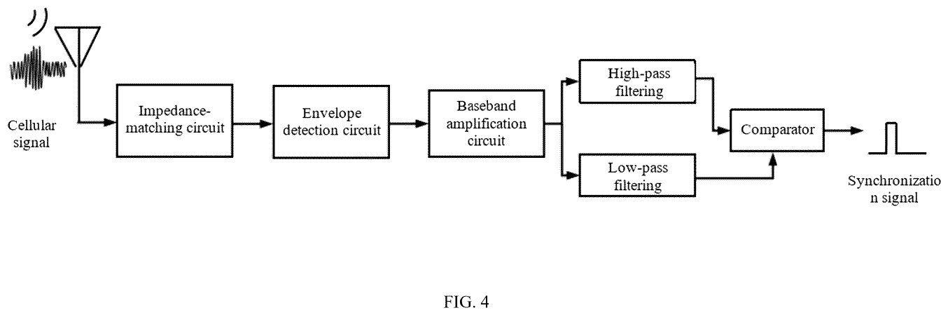

In the step S20, as shown in FIG. 4, the envelope-detection circuit comprises an impedance-matching circuit, an envelope-detection circuit, a base-band amplification circuit, a filtering circuit, and a comparator, which are electrically connected in sequence. In this embodiment, utilizing, by the backscatter tag, an envelope-detection circuit to convert the ambient cellular OFDM signal into a digital pulse signal comprises:
S201, after the ambient cellular OFDM signal passes through the impedance-matching circuit, receiving only an ambient cellular OFDM signal in a frequency band carrying the synchronization information, while suppressing ambient cellular OFDM signals in other frequency bands;
S202, acquiring a signal envelope when the received ambient cellular OFDM signal passes through the envelope-detection circuit, and then improving a signal-to-noise ratio by the base-band amplification circuit; and
S203, using, by the backscatter tag, the filtering circuit and the comparator to convert the synchronization information into a digital pulse signal that is capable of being read by a tag control module.

Further, in the step S20, establishing, by the backscatter tag, synchronization with the transmitting terminal by detecting a rising edge of the digital pulse signal comprises: determining, by the backscatter tag, appearance time of the PSS signal by capturing the rising edge of the digital pulse signal and establishing time synchronization with the transmitting terminal, so as to avoid backscatter tag information being modulated to a CP part of the ambient cellular OFDM signal. In the step S20, as shown in FIG. 3, the digital pulse signal output by the envelope detection circuit not only contains the synchronization information, but also the changes in its pulse width carry the control information from the transmitting terminal for the backscatter tag.

Still further, identifying, by the backscatter tag, the control information of the transmitting terminal by detecting multi-segment pulse widths of the digital pulse signal comprises:
S204, collecting, by the backscatter tag, a plurality of pulse widths of the digital pulse signal and averaging the pulse widths to obtain a decision threshold;
S205, performing 0-1 decisions on the pulse widths of the digital pulse signal and storing a result thereof, wherein in this embodiment, a shift register is utilized to store the pulse widths of the digital pulse signal and the judgment result;
S206, every time a control bit is collected, utilizing, by the backscatter tag, a shift register to update the plurality of stored bits; using data of these bits by the backscatter tag to perform a correlation calculation with a corresponding PN sequence thereof, comparing a peak value of the calculation result with a preset threshold to determine whether a current backscatter tag is a target backscatter tag controlled by the transmitting terminal, and determining a start time of backscattering from a peak point of the correlation calculation; and
S207, if the current backscatter tag is the target backscatter tag controlled by the transmitting terminal, starting backscattering at this time backscattering of a previous backscatter tag is finished, which completes control of a backscatter communication process of the backscatter tag by the transmitting terminal.

On this basis, the present application provides a method for synchronizing and controlling backscatter communication based on an ambient cellular OFDM signal, which is applicable to ambient cellular OFDM signals of any bandwidth. When the power and frequency band of the ambient cellular OFDM signal received by the backscatter tag match, synchronization between backscatter tags within a range of 12 meters and the transmitting terminal and control of the backscatter tags by the transmitting terminal can be achieved. The present application is capable of achieving reliable synchronization and control without relying on additional excitation signals, which is an urgent problem to be solved in the current backscatter technology.

On the basis of the above embodiments, the present application also provides simulation results and a verification platform to verify the performance of the above embodiments.

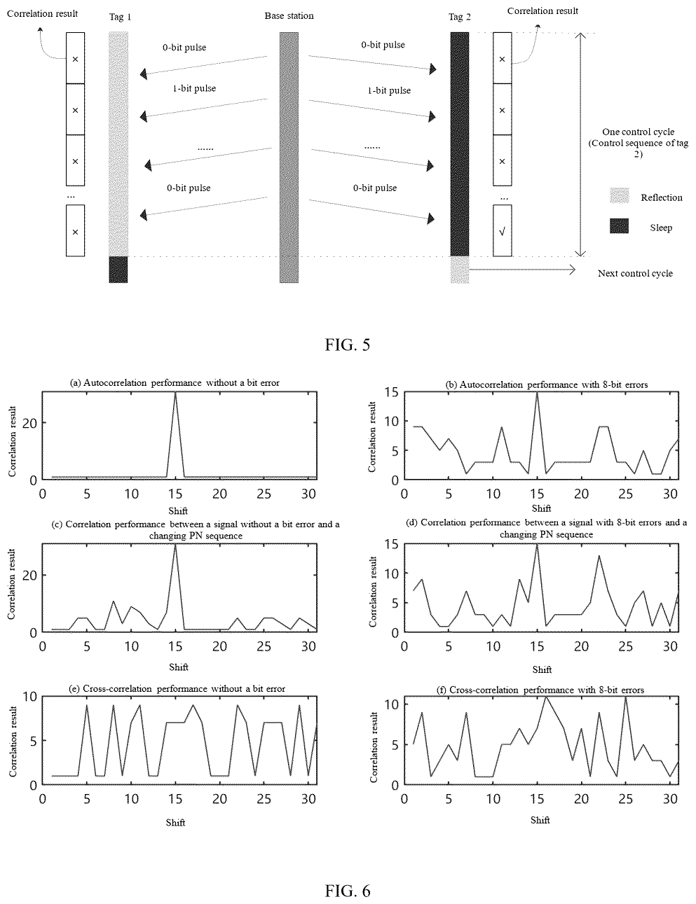

First, the performance of the proposed method for controlling backscatter communication based on an ambient cellular OFDM signal is verified through simulation, utilizing two PN sequences of: PN₁: 0000101011101100011111001101001 and PN₂: 0000110101001000101111101100111. In the simulation, the correlation performance of the backscatter tag using PN₁ without an error or with 8-bit errors is tested under the following conditions: when the transmitting terminal only transmits PN₁ (autocorrelation); when it alternately transmits PN₁ and PN₂ (correlation with the changing PN sequence); and when it only transmits PN₁ (cross-correlation). In FIG. 6(a) to FIG. 6(d), regardless of the up-to-8-bit errors or the changing PN sequences, the correlation peaks of the backscatter tag are all shifted by 15. This indicates that the backscatter tag is capable of recognizing the PN₁ control information transmitted by the transmitting terminal. In FIG. 6(e) and FIG. (f), even with 8-bit errors, the cross-correlation performance of the backscatter tag remains excellent. The correlation results are far lower than the correlation peaks in FIG. 6(a) to FIG. (d), which means the backscatter tag is capable of distinguishing the non-PN₁ control information transmitted by the transmitting terminal.

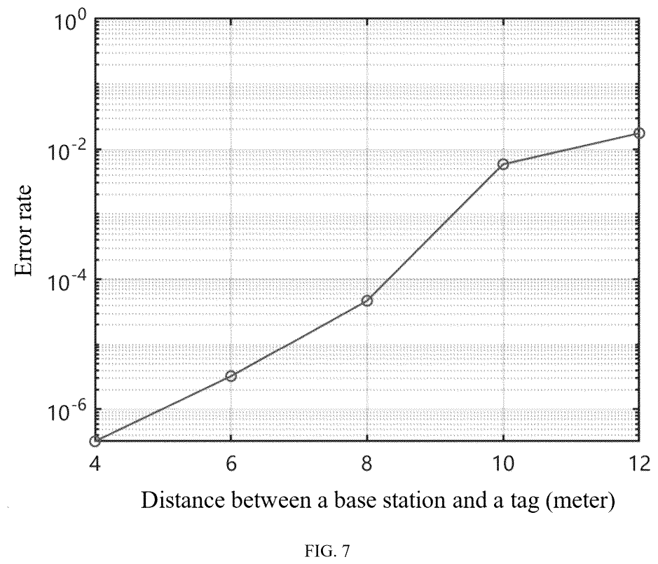

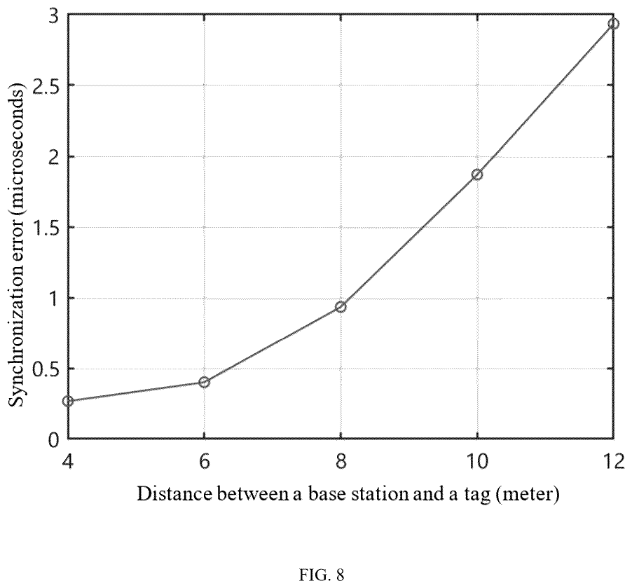

Next, the performance of the proposed method for synchronizing and controlling backscatter communication based on an ambient cellular OFDM signal is verified on the verification platform. In the step S10, the transmitting terminal is implemented by an NI USRP2952R. The carrier frequency is 845 MHz, the average power is 15 dBm. The addition of synchronization and control information increases the peak-to-average power ratio of the ambient cellular OFDM signal by 3.5 dB. The ambient cellular OFDM signal is a 5M LTE signal. In the step S20, the backscatter tag consists of an envelope detection circuit as shown in FIG. 4 and a ZYNQ 7020 Field-Programmable Gate Array (FPGA). When the distance between the transmitting terminal and the backscatter tag ranges from 4 to 12 meters, the control and synchronization performance of the backscatter tag is shown in FIG. 7 and FIG. 8 respectively. Herein, the error rate shown in FIG. 7 refers to a probability that the backscatter tag fails to perform backscattering at correct time.

On this basis, the method for synchronizing and controlling backscatter communication based on an ambient cellular OFDM signal in the present application is applicable to ambient cellular OFDM signals of any bandwidth. When the power and frequency band of the ambient cellular OFDM signal received by the backscatter tag match, synchronization between backscatter tags within a range of 12 meters and the transmitting terminal and control of the backscatter tags by the transmitting terminal can be achieved. The core advantage of the present application is that reliable synchronization and control is achieved without relying on additional excitation signals, which is an urgent problem to be solved in the current backscatter technology.

The above is a specific description of the preferred embodiments of the present application. However, the present application is not limited to the above-mentioned embodiments. Those skilled in the art can make various equivalent modifications or substitutions without departing from the spirit of the present application. These equivalent modifications or substitutions are all included within the scope defined by the claims of this application.

What is claimed is:

1. A method for synchronizing and controlling backscatter communication based on an ambient cellular Orthogonal Frequency Division Multiplexing (OFDM) signal, comprising the following steps:
S10, transmitting, by a transmitting terminal, an ambient cellular OFDM signal, which carries synchronization and control information; and
S20, acquiring, by a backscatter tag, the synchronization and control information from the ambient cellular OFDM signal, comprising:
utilizing, by the backscatter tag, an envelope-detection circuit to convert the ambient cellular OFDM signal into a digital pulse signal;
establishing, by the backscatter tag, synchronization with the transmitting terminal by detecting a rising edge of the digital pulse signal; and
identifying, by the backscatter tag, the control information of the transmitting terminal by detecting multi-segment pulse widths of the digital pulse signal.

2. The method according to claim 1, wherein the step S10 comprises the following steps:
S101, increasing, by the transmitting terminal, a Primary Synchronization Signal (PSS) signal for synchronization with the backscatter tag, wherein the PSS signal is a primary synchronization signal;
S102, generating, by the transmitting terminal, a corresponding control sequence according to a tag needed to be controlled; and
S103, mapping, by the transmitting terminal, bit information corresponding to the control sequence to a relative size of power of a Secondary Synchronization Signal (SSS) signal.

3. The method according to claim 2, wherein the control sequence is a Pseudorandom Noise (PN) pseudo-random sequence, and the SSS signal is a secondary synchronization signal.

4. The method according to claim 2, wherein in the step S101, the transmitting terminal increases the transmission power of the PSS signal of the ambient cellular OFDM signal by several dBs, so that the power of an OFDM symbol where the PSS signal is located is relatively large, and the rising edge is capable of being detected by the backscatter tag in an envelope-detection manner.

5. The method according to claim 2, wherein in the step S102, the transmitting terminal utilizes a control sequence of an appropriate length to distinguish different backscatter tags according to the number of backscatter tags needed to be controlled.

6. The method according to claim 2, wherein in the step S103, in Long Term Evolution (LTE), the PSS signal and the SSS signal exist in two consecutive OFDM symbols; and
in 5G New Radio (NR), the PSS signal and the SSS signal exist in the same Synchronization Signal Block (SSB) block, which are two relatively close OFDM symbols, and the SSB block is a synchronization signal and physical broadcast channel block.

7. The method according to claim 1, wherein in the step S20, the envelope-detection circuit comprises an impedance-matching circuit, an envelope-detection circuit, a base-band amplification circuit, a filtering circuit, and a comparator, which are electrically connected in sequence; and
utilizing, by the backscatter tag, an envelope-detection circuit to convert the ambient cellular OFDM signal into a digital pulse signal comprises:
S201, after the ambient cellular OFDM signal passes through the impedance-matching circuit, receiving only an ambient cellular OFDM signal in a frequency band carrying the synchronization information, while suppressing ambient signals in other frequency bands;
S202, acquiring a signal envelope when the received ambient cellular OFDM signal passes through the envelope-detection circuit, and then improving a signal-to-noise ratio by the base-band amplification circuit; and
S203, using, by the backscatter tag, the filtering circuit and the comparator to convert the synchronization information into a digital pulse signal that is capable of being read by a tag control module.

8. The method according to claim 7, wherein in the step S20, establishing, by the backscatter tag, synchronization with the transmitting terminal by detecting a rising edge of the digital pulse signal comprises:
determining, by the backscatter tag, an appearance time of the PSS signal by capturing the rising edge of the digital pulse signal and establishing time synchronization with the transmitting terminal, so as to avoid backscatter tag information being modulated to a Cyclic Prefix (CP) part of the ambient cellular OFDM signal.

9. The method according to claim 8, wherein in the step S20, identifying, by the backscatter tag, the control information of the transmitting terminal by detecting multi-segment pulse widths of the digital pulse signal comprises:
S204, collecting, by the backscatter tag, a plurality of pulse widths of the digital pulse signal and averaging the pulse widths to obtain a decision threshold;
S205, performing 0-1 decisions on the pulse widths of the digital pulse signal and storing a result thereof;
S206, every time a control bit is collected, utilizing, by the backscatter tag, a shift register to update the plurality of stored bits; using data of these bits by the backscatter tag to perform a correlation calculation with a PN pseudo-random sequence corresponding thereto once, comparing a peak value of the calculation result with a preset threshold to determine whether a current backscatter tag is a target backscatter tag controlled by the transmitting terminal, and determining a start time of backscattering from a peak point of the correlation calculation; and
S207, if the current backscatter tag is the target backscatter tag controlled by the transmitting terminal, starting backscattering at this time backscattering of a previous backscatter tag is finished, which completes control of a backscatter communication process of the backscatter tag by the transmitting terminal.

10. The method according to claim 9, wherein in the step S205, the shift register is utilized to store multiple groups of pulse widths of the digital pulse signal.
